(19) United States
(12) Patent Application Publication
(10) Pub. No.: US 2025/0076503 A1
(43) Pub. Date: Mar. 6, 2025

(54) COMBINING MULTIBAND SIGNALS IN LIDAR SYSTEMS

(71) Applicant: SiLC Technologies, Inc., Monrovia, CA (US)

(72) Inventors: Behnam Behroozpour, South San Francisco, CA (US); Mehdi Asghari, La Canada Flintridge, CA (US)

(21) Appl. No.: 18/241,766

(22) Filed: Sep. 1, 2023

(51) Int. Cl. G01S 17/34; G01S 7/481; G01S 7/4861; G01S 17/42

(52) U.S. Cl. CPC G01S 17/34; G01S 7/4811; G01S 7/4861; G01S 17/42

(57) ABSTRACT

The LIDAR system outputs a system output signal and receives a system return signal that includes light from the system output signal that was reflected by an object located outside of the LIDAR system. The LIDAR system includes data lines that each carries a different preliminary channel signal. A selection of the preliminary channel signals is beating at a beat frequency. Each of the preliminary channel signals in the selection of the preliminary channel signals is generated from light included in the system return signal. The LIDAR system includes bandpass filter components. Each of the bandpass filter components receives a different one of the preliminary channel signals and outputs a channel signal on a different filtered data line. The channel signal output by each of the bandpass filter components is a representation of the preliminary channel signal received by the bandpass filter component filtered by one or more bandpass filters included in the bandpass filter component.

### FIELD

The invention relates to optical devices. In particular, the invention relates to LIDAR systems.

### BACKGROUND

LIDAR systems output a system output signal. Objects in the path of the system output signal reflect the system output signal. A portion of the reflected light returns to the LIDAR system as a system return signal. The LIDAR system processes the system return signal to generate LIDAR data that indicates a radial velocity and/or distance between the objects and the LIDAR system.

LIDAR systems can be classified as coaxial (sometimes called monostatic) or biaxial (sometimes called bistatic). In a coaxial LIDAR system, the path that the light travels after being output from the LIDAR system is also traveled by the reflected light returning to the LIDAR system. However, in biaxial systems, the path that the light travels after being output from the LIDAR system is different from the path traveled by the reflected light returning to the LIDAR system.

There are a variety of circumstances where biaxial systems are preferable to coaxial systems. For instance, biaxial systems can often have reduced levels of loss in returned light signals. However, LIDAR systems typically include a beam steerer that steers the system output signal to different sample regions in a field of view. In biaxial systems, this change in the direction of the system output signal changes the angle between the returning light and the LIDAR system. This angle change can reduce the collection efficiency for the light returning to the LIDAR system. As a result, there is a need for an improved LIDAR system.

### SUMMARY

A LIDAR system outputs a system output signal and receives a system return signal that includes light from the system output signal that was reflected by an object located outside of the LIDAR system. The LIDAR system includes data lines that each carries a different preliminary channel signal. A selection of the preliminary channel signals is beating at a beat frequency. Each of the preliminary channel signals in the selection of the preliminary channel signals is generated from light included in the system return signal. The LIDAR system includes bandpass filter components. Each of the bandpass filter components receives a different one of the preliminary channel signals and outputs a channel signal on a different filtered data line. The channel signal output by each of the bandpass filter components is a representation of the preliminary channel signal received by the bandpass filter component filtered by one or more bandpass filters included in the bandpass filter component.

A LIDAR system outputs a system output signal and receives a system return signal that includes light from the system output signal that was reflected by an object located outside of the LIDAR system. The LIDAR system includes data lines that each carries a different preliminary channel signal. A selection of the preliminary channel signals is beating at a beat frequency. Each of the preliminary channel signals that is included in the selection of the preliminary channel signals is generated from light included in the system return signal. The LIDAR system includes current mirrors that each receives a different one of the preliminary channel signals and outputs a channel signal on a different filtered data line. Each of the current mirrors includes a bandpass filter positioned such that each channel signal is a copy of one of the preliminary channel signals filtered by one of the bandpass filters.

### BRIEF DESCRIPTION OF THE FIGURES

FIG. 1A is a topview of a biaxial LIDAR system.

FIG. 1B is a schematic of a composite signal generator that is suitable for use in a LIDAR chip constructed according to FIG. 5A.

FIG. 1C is a schematic of an example of a portion of the electronics that are suitable for use with the LIDAR system of FIG. 1A.

FIG. 1D is a graph illustrating the frequency versus time pattern for a system output signal and/or a LIDAR output signal.

FIG. 2A is a schematic of an example of a current mirror that serves as a bandpass filtration component.

FIG. 2B is a graph illustrating selection of bandpass filters for use in different composite signal generators.

FIG. 2C is a schematic of another example of a bandpass filtration component.

FIG. 3A through FIG. 3F illustrate one possible example of the construction of components that are suitable for use with the LIDAR system. FIG. 3A a topview of portion of a LIDAR chip having an interface between a free space region and reference waveguide.

FIG. 3B is a cross section of the LIDAR chip shown in FIG. 3A taken along the line labeled B in FIG. 3A.

FIG. 3C is a cross section of the LIDAR chip shown in FIG. 3A taken along the line labeled C in FIG. 3A.

FIG. 3D is a topview of an interface between an entry side of a waveguide array and a free space region.

FIG. 3E is a topview of a portion of the LIDAR chip where multiple channel waveguide(s) terminate at a lateral side of the LIDAR chip.

FIG. 3F is a cross section of the portion of the LIDAR chip shown in FIG. 3E taken along the line labeled F in FIG. 3E.

FIG. 3G is a topview of a portion of the LIDAR chip where a channel waveguide terminates at a lateral side of the LIDAR chip.

FIG. 3H is a cross section of the device taken along the line labeled H in FIG. 3G.

FIG. 4A is a cross section of a portion of a LIDAR system showing an example of an interface between a LIDAR chip, a beam steerer, and a signal shaper.

FIG. 4B is a cross section of a portion of a LIDAR system showing an example of an interface between a LIDAR chip, a beam steerer, and a signal shaper.

FIG. 5 is a cross section of an in-line light sensor that is suitable for use in a LIDAR chip.

### DESCRIPTION

A LIDAR system outputs a system output signal and receives a system return signal that includes light from the system output signal that was reflected by an object located outside of the LIDAR system. The LIDAR system also includes multiple different channel waveguides. A selection of the channel waveguides can receive a LIDAR input signal that includes light from the system output signal. The portion of the LIDAR input signal that enters a channel waveguide serves as a comparative signal guided by the channel waveguide. The channel waveguides are arranged such that the selection of channel waveguides that carry comparative signals changes in response to changes in the location of the object relative to the LIDAR system.

The LIDAR system includes data lines that each carries a different preliminary channel signal. A portion of the preliminary channel signals are each generated from light in a different one of the comparative signals and is beating at a beat frequency. Another portion of the preliminary channel signals is not beating at the beat frequency but carries noise. The portion of the preliminary channel signals that are beating changes in response to the changes in selection of channel waveguides that carry comparative signals.

The LIDAR system includes a bandpass filter components. Each of the bandpass filter components receives a different one of the preliminary channel signals and outputs a channel signal on a different filtered data line. Each of the bandpass filter components includes a bandpass filter positioned such that each of the channel signals is a copy of one of the preliminary channel signals filtered by one of the bandpass filters. The channel signal can then be added and processed so as to determine the beat frequency for use in calculating LIDAR data.

The bandpass filters remove the noise from the channel signals before the noise is multiplied by adding multiple different channel signals. In some instances, each of the bandpass filter components includes a current mirror that includes the one or more bandpass filters. The use of the mirrors allows the current of the preliminary channel signal to be copied to the channel signal without permutation of the current of the preliminary channel signal. As a result, the channel signals are filtered copies of the preliminary channel signals and the resulting data signal carried on the sensor output line carries accurately added copies of the filtered preliminary channel signals.

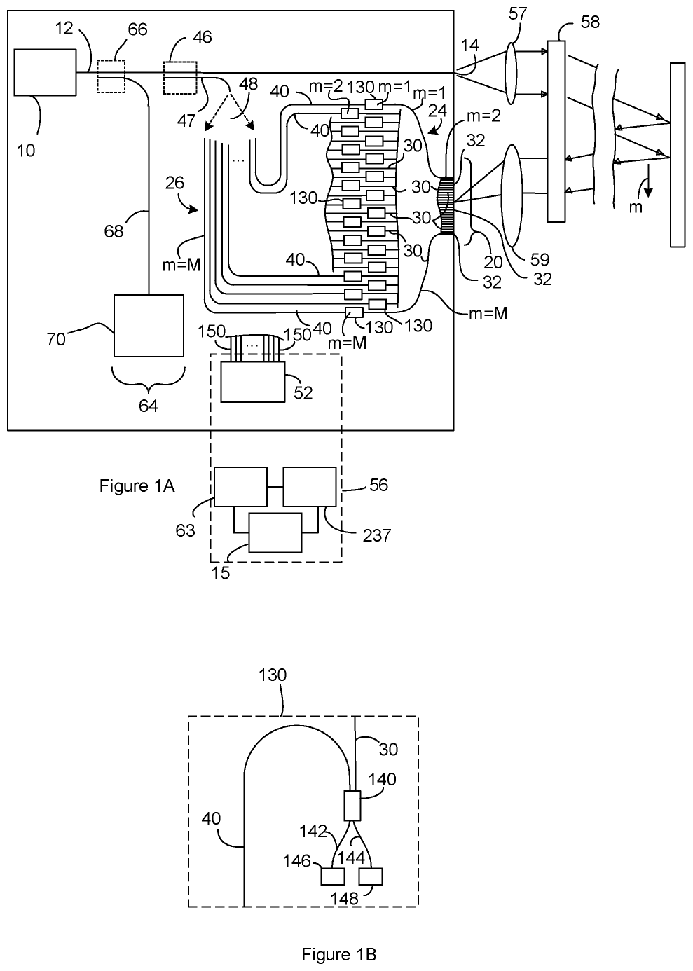

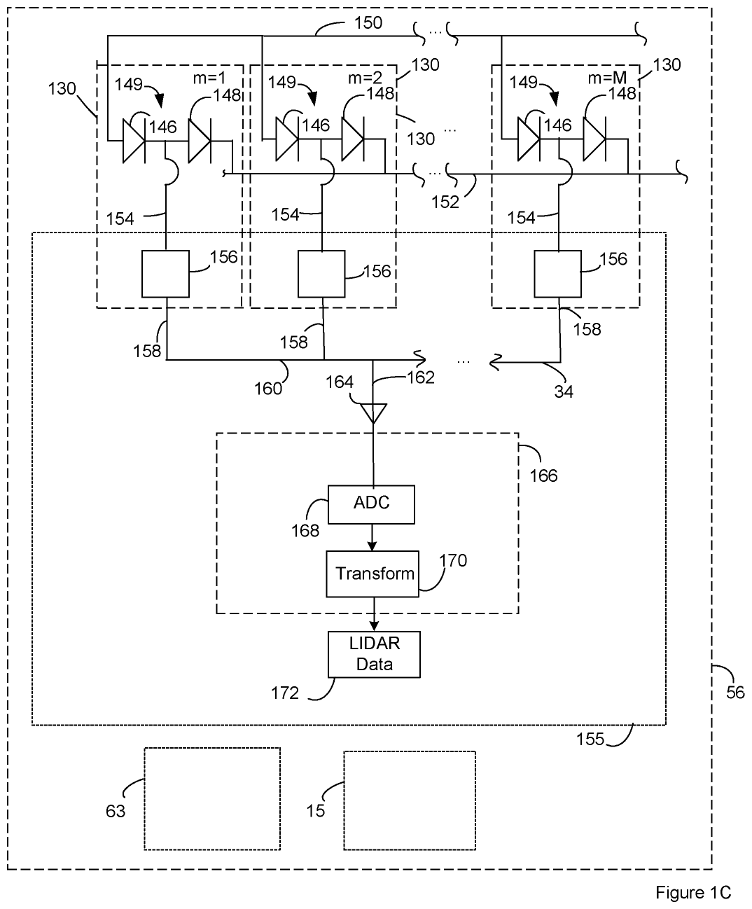

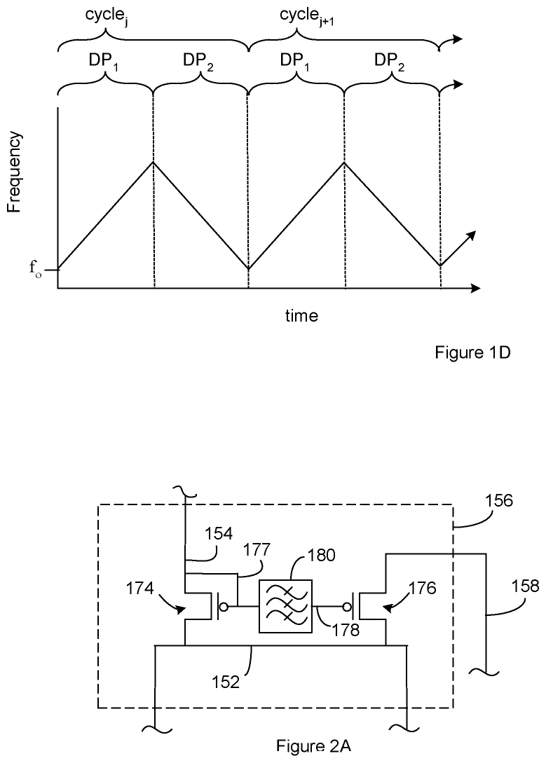

FIG. 1A is a topview of a schematic of a LIDAR system. The LIDAR system includes a LIDAR chip with a light source 10 that outputs an outgoing LIDAR signal. A suitable light source 10 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip also includes a utility waveguide 12 that receives the outgoing LIDAR signal from the light source 10. The utility waveguide 12 terminates at an output component 14 and carries the outgoing LIDAR signal to the output component 14. The output component 14 can be positioned such that the outgoing LIDAR signal traveling through the output component 14 exits the chip and serves as a LIDAR output signal. For instance, the output component 14 can be positioned at an edge of the chip so the outgoing LIDAR signal traveling through the output component 14 exits the chip and serves as a LIDAR output signal.

Light from the LIDAR output signal travels away from the LIDAR system and may be reflected by objects in the path of the LIDAR output signal. When the LIDAR output signal is reflected, at least a portion of the reflected light travels returns to the LIDAR system in a system return signal. Additionally, at least a portion of the reflected returns to the LIDAR system as a LIDAR input signal that includes light from the system return signal. IN some instances, the system return signal can serve as the LIDAR input signal. The LIDAR chip can include a first waveguide array 24 that includes multiple channel waveguides 30. Light from the LIDAR input signal enters one or more of the channel waveguides 30. For instance, the channel waveguides 30 can each terminate at a facet 32 and the LIDAR input signal enters one or more of the channel waveguides 30 through the corresponding facets 32. The portion of the LIDAR input signal that enters a channel waveguide 30 can serve as a comparative signal that includes or consists of light from the LIDAR input signal. Each of the channel waveguides 30 is configured to carry the comparative signal received by that channel waveguide 30 to a composite signal generator 130. The channel waveguides 30 and the associated composite signal generators 130 can be associated with a channel index with a value of m=1 to M where M represents the number of composite signal generators 130 and/or the number of channel waveguides 30.

The LIDAR chip includes a splitter 46 that moves a portion of the outgoing LIDAR signal from the utility waveguide 12 onto a reference waveguide 47 as a reference signal precursor. Suitable splitters 46 include, but are not limited to, optical couplers, y-junctions, and multimode interference devices (MMIs).

The reference waveguide 47 carries the reference light signal to free space region 48. The reference light signal can travel through the free space region 48 to the second waveguide array 26. The second array waveguides 40 in the second waveguide array 26 are arranged to receive the reference light signal from the free space region 48. The second array waveguides 40, the free space region 48 and the reference waveguide 47 can be configured such that the reference light signal is distributed among the second array waveguides 40. For instance, the second array waveguides 40, the free space region 48 and the reference waveguide 47 can be arranged such that the free space region 48 operates as part of a star coupler. At least a portion each of the second array waveguides 40 each receives a portion of the reference signal precursor. In some instances, each of the second array waveguides 40 receives a portion of the reference signal precursor. The portion of the reference signal precursor that is received by a second array waveguide 40 serves as a reference signal. At least a portion of the second array waveguides 40 can carry one of the reference signals to one of the composite signal generators 130. In some instances, each of the second array waveguides 40 can carry one of the reference signals to a different one of the composite signal generators 130. Accordingly, the second array waveguides 40 and reference signals can each be associated with a different one of the channel indices. For instance, each of the second array waveguides 40 and reference signals can be associated with the same channel index as the composite signal generators 130 that receives the reference signal.

Although FIG. 1A illustrates the free space region 48 configured as a star coupler, other signal distributors can be used to distribute the reference signal precursor across multiple second array waveguides 40. For instance, cascaded y-junctions can serve as a signal distributor for distributing a reference signal precursor across multiple array waveguides 40. Other suitable signal distributors include, but are not limited to, cascaded multimode interference devices (MMIs).

The LIDAR system can optionally include components in addition to the LIDAR chip. For instance, the LIDAR system can include one or more signal shapers that shape the signals output from the LIDAR system and/or one or more beam steerers that can be used to steer a system output signal from to different sample regions in the field of view. For instance, the LIDAR system of FIG. 1A includes a first signal shaper 57 that receives the LIDAR output signal and outputs a shaped output signal. A beam steerer 58 receives the shaped output signal and outputs the system output signal. The beam steerer can steer the system output signal to the desired sample region in the field of view. When the system output signal is reflected by an object, the reflected light can serve as a system return signal. The beam steerer 58 can receive the system return signal as shown in FIG. 1A or the beam steerer 58 can be constructed such that the system return signal bypasses the beam steerer 58. The LIDAR system also includes a second signal shaper 59 that receives the system return signal and outputs the LIDAR input signal that is received by the LIDAR chip.

In FIG. 1A, the first signal shaper 57 is a lens configured to collimate the shaped output signal and the second signal shaper 59 is a lens configured to focus the LIDAR input signal. In some instances, the second signal shaper 59 is configured to focus the LIDAR input signal at or near a facet 32 of one or more of the channel waveguides 30. The first signal shaper 57 and the second signal shaper 59 can be combined in a single component. For instance, a single lens can serve as the first signal shaper 57 and the second signal shaper 59.

When the first signal shaper 57 and the second signal shaper 59 are each a lens, the lens serving as the second signal shaper 59 can have a wider aperture than the lens serving as the first signal shaper 57. The increased aperture of the lens serving as the second signal shaper 59 can improve light collection efficiency. In some instances, the improvement in light collection efficiency is desirable to overcome optical loss that results from the offset between the output component 14 and the facets 32 of one or more of the channel waveguides 30. A suitable ratio for the aperture of the lens serving as the second signal shaper 59: the aperture of the lens serving as the first signal shaper 57 includes apertures greater than 1:1, 2:1, or 3:1 and/or less than 5:1, 10:1, or 20:1.

In some instances, components such as signal shapers and beam steerers can be mounted on and/or integrated with the LIDAR chip. In instances, when the LIDAR system excludes components in addition to the LIDAR chip, the signal output from the LIDAR chip can serve as the system output signal. For instance, when a LIDAR system includes a LIDAR chip constructed according to FIG. 1A and excludes components in addition to the LICAR chip, the LIDAR output signal can serve as the system output signal.

The LIDAR system can include electronics 56. When the LIDAR system includes a beam steerer, the LIDAR system can include a steering controller 15 that is configured to operate the beam steerer so as to steer the system output signals to different sample regions within the field of view of the LIDAR system.

The angle of incidence of the LIDAR input signal on the first waveguide array 24 and/or the location where the LIDAR input signal is incident on the first waveguide array 24 can change in response to the steering of the system output signal and/or in response to changes in the distance between the object and the LIDAR system. For instance, the angle of incidence of the LIDAR input signal on the on the edge of the LIDAR chip that includes the facets 32 of the channel waveguides 30 and/or the location where the LIDAR input signal is incident on the edge of the LIDAR chip that includes the facets 32 of the channel waveguides 30 can change in response to the steering of the system output signal and/or in response to changes in the distance between the object and the LIDAR system. As a result, the selection of the channel waveguides 30 that receive the LIDAR input signal can change in response to steering the system output signals to different sample regions within the field of view of the LIDAR system and/or in response to changes in the distance between the object and the LIDAR system. Accordingly, the selection of the channel waveguides that receives the LIDAR input signal changes in response to changes in the location of the object relative to the LIDAR system.

In some instances, the location where the LIDAR input signal is incident on the edge of the LIDAR chip changes in response to steering of the system output signal by more than more than 5 μm, 10 μm, or 15 μm and/or less than 20 μm, 30 μm, or 50 μm.

The electronics 56 can also include a light source controller 63. The light source controller 63 can operate the light source 10 such that the outgoing LIDAR signal, and accordingly a resulting system output signal, has a particular frequency versus time pattern. For instance, the light source controller 63 can operate the light source such that the outgoing LIDAR signal, and accordingly a system output signal, has different chirp rates during different data periods.

The LIDAR chip can optionally include a control branch 64 for controlling the operation of the light source 10. For instance, the control branch 64 can provide a feedback loop that the light source controller 63 uses in operating the light source such that the outgoing LIDAR signal has the desired frequency versus time pattern. The control branch 64 includes a directional coupler 66 that moves a portion of the outgoing LIDAR signal from the utility waveguide 12 onto a control waveguide 68. The coupled portion of the outgoing LIDAR signal serves as a tapped signal. Although FIG. 1 illustrates a directional coupler 66 moving a portion of the outgoing LIDAR signal onto the control waveguide 68, other signal-tapping components can be used to move a portion of the outgoing LIDAR signal from the utility waveguide 12 onto the control waveguide 68. Examples of suitable signal tapping components include, but are not limited to, y-junctions, and MMIs.

The control waveguide 58 carries the tapped signal to a feedback system 70. The feedback system 70 can include one or more light sensors (not shown) that convert light signals carried by the feedback system 70 to electrical signals that are output from the feedback system 70. The light source controller 63 can receive the electrical signals output from the feedback system 70. During operation, the light source controller 63 can adjust the frequency of the outgoing LIDAR signal in response to output from the electrical signals output from the feedback system 70. An example of a suitable construction and operation of feedback system 70 and light source controller 63 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

FIG. 1B illustrates an example of a composite signal generator 130 that is suitable for use as any, all, or each of the composite signal generators 130 in the LIDAR chip of FIG. 1A. The illustrated composite signal generator 130 includes a light signal combiner 140 configured to receive light signals from one of the second array waveguides 40 and one of the channel waveguides 30. When the second array waveguide 40 receives a reference signal, the second array waveguide 40 carries the reference signal to the light signal combiner 140. When a channel waveguide 30 receives a comparative signal, the channel waveguide 30 carries the comparative signal to the light signal combiner 140. When the light signal combiner 140 receives a comparative signal and a reference signal, the light signal combiner 140 combines the comparative signal and the reference signal into a composite signal. Due to the difference in frequencies between the comparative signal and the reference signal, the composite signal is beating at a beat frequency.

The light signal combiner 140 also splits the composite signal onto a first detector waveguide 142 and a second detector waveguide 144. The first detector waveguide 142 carries a first portion of the composite signal to a first light sensor 146 that converts the first portion of the composite signal to a first electrical signal. The second detector waveguide 144 carries a second portion of the composite signal to a second light sensor 148 that converts the second portion of the composite signal to a second electrical signal. Examples of suitable light sensors include germanium photodiodes (PDs), and avalanche photodiodes (APDs).

In some instances, the light signal combiner 140 splits the composite signal such that the portion of the comparative signal included in the first portion of the composite signal is phase shifted by 180° relative to the portion of the comparative signal in the second portion of the composite signal but the portion of the reference signal in the first portion of the composite signal is not phase shifted relative to the portion of the reference signal in the second portion of the composite signal. Alternately, the light signal combiner 140 splits the composite signal such that the portion of the reference signal in the first portion of the composite signal is phase shifted by 180° relative to the portion of the reference signal in the second portion of the composite signal but the portion of the comparative signal in the first portion of the composite signal is not phase shifted relative to the portion of the comparative signal in the second portion of the composite signal.

The electronics 56 can connect the first light sensor 146 and the second light sensor 148 in each of the composite signal generators 130 as a balanced detector 149 that serves as a light detector that converts optical energy to electrical energy. For instance, the first light sensor 146 and the second light sensor 148 in each composite signal generator 130 can be connected in series between a first parallel line and a second parallel line as shown in FIG. 1C. The first sensor line 150 and the second sensor line 152 can connect the balanced detector 149 from different composite signal generators 130 in parallel and can be used to apply a bias across the balanced detectors 149.

The serial connection in each of the balanced detectors is in communication with a data line 154 that carries the output from the balanced detector as a preliminary channel signal. Although a balanced detector is disclosed as serving as a light detector, other components and/or arrangements can serve as a light detector. For instance, a single photodetector can serve as a light detector that outputs a preliminary channel signal on a data line 154.

The electronics 56 include a data processor 155 configured to generate the LIDAR data. The beat frequency identifier 166 receives the preliminary channel signals from the data lines 154. Each of the data lines 154 carries one of the preliminary channel signals to a bandpass filtration component 156. Each of the bandpass filtration components 156 includes one or more bandpass filters (not shown) and is configured to output a channel signal that represents the preliminary channel signal filtered by the bandpass filter. Each of the bandpass filtration components 156 outputs the filtered current on a filtered data line 158 as the channel signal. The preliminary channel signals and the channel signals can be analogy signals. As is evident from FIG. 1C, the data lines 154, preliminary channel signals, bandpass filtration component 156, filtered data lines 158, and channel signals can each be associated with one of the channel indices with a value of m=1 to M since each of them is or carries a signal generated from a comparative signal received on a different one of the channel waveguides 30. When one or more of the preliminary channel signals includes a contribution from a comparative signal and a reference signal, the resulting data signal also includes a contribution from one or more comparative signals and one or more reference signals. In these instances, the preliminary channel signal and the resulting data signal having the same channel index m is beating at the beat frequency of the composite signal(s) having the same channel index due to the difference in the frequencies of the contribution of the comparative signal(s) and the contribution of the reference signal(s). All or a portion of the channel waveguides 30 may not receive a comparative signal when an object is not present to reflect the system output signal or when the LIDAR input signal is directed to other channel waveguides 30. The composite signal generator 130 associated with this portion of the channel waveguides can continue receiving the reference signal. As a result, all or a portion of the channel signals can have a contribution from a reference signal but not from a comparative signal. Accordingly, a selection of the channel signals and the preliminary channels signals is beating at the beat frequency. Additionally, the selection of the channel signals and the preliminary channels signals beating at the beat frequency can change in response to changes in the position of the object relative to the LIDAR system.

The LIDAR system can include an adder that adds or combines the channel signals to form a data signal carried on a sensor output line 162. As a result, the channel signals from each of the different channels, i=m through i=M, are added together to provide the data signal. In FIG. 1C, the filtered data lines 158 are connected by a common filtered data line 160. The common filtered data line 160 acts as an example of an adder that adds the channel signals to form a data signal carried on a sensor output line 162. When one or more of the preliminary channel signals and the resulting channel signals includes a contribution from a comparative signal and a reference signal, the resulting data signal also includes a contribution from one or more comparative signals and one or more reference signals. In these instances, the data signal is beating at the beat frequency of the composite signal(s) due to the difference in the frequencies of the contribution of the comparative signal(s) and the contribution of the reference signal(s). When a portion of the preliminary channel signals and the resulting channel signals include a contribution from a reference signal but not from a comparative signal, the contribution from the reference signal is a source of noise in the preliminary channel signals and the resulting channel.

The sensor output line 162 that carries the data signals can optionally include an amplifier 164. Suitable amplifiers 164 include, but are not limited to, transimpedance amplifiers (TIAs).

The data processor 155 includes a beat frequency identifier 166 configured to identify the beat frequency of the data signal. The beat frequency identifier 166 includes an Analog-to-Digital Converter (ADC) 168 that receives the data signal from the sensor output line 162. The Analog-to-Digital Converter (ADC) 168 converts the data signal from an analog form to a digital form and outputs a digital data signal. The digital data signal is a digital representation of the data signal.

The beat frequency identifier 166 includes a mathematical transformer 170 configured to receive the digital data signal. The mathematical transformer 170 is configured to perform the mathematical operation on the received digital data signal. Examples of suitable mathematical operations include, but are not limited to, mathematical transforms such as Fourier transforms. In one example, the mathematical transformer 170 performs a Fourier transform on the digital signal so as to convert from the time domain to the frequency domain. The mathematical transform can be a real transform such as a real Fast Fourier Transform (FFT). A real Fast Fourier Transform (FFT) can provide an output that indicates magnitude as a function of frequency.

The mathematical transformer 170 can include a peak finder (not shown) configured to identify peaks in the output of the mathematical transformer 170. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The electronics include a LIDAR data generator 172 that receives the output from the mathematical transformer 170. The LIDAR data generator 172 treats the frequency at the identified peak as the beat frequency of the beating signals that each results from all or a portion of a comparative signal beating against all or a portion of a reference signal. The LIDAR data generator 172 can use the identified beat frequencies in combination with the frequency pattern of the LIDAR output signal and/or the system output signal to generate the LIDAR data. FIG. 1D illustrates an example of a suitable frequency pattern for a LIDAR output signal and/or the system output signal. FIG. 1D has a solid line that shows an example of a suitable frequency pattern for the LIDAR output signal and the system output signal. Accordingly, the solid line also represents the frequency pattern for the reference signal.

FIG. 1D shows the frequency versus time pattern over a sequence of two cycles labeled cycleⱼ and cycleⱼ₊₁. In some instances, the frequency versus time pattern is repeated in each cycle as shown in FIG. 1D. The illustrated cycles do not include re-location periods and/or re-location periods are not located between cycles. As a result, FIG. 1D illustrates the results for a continuous scan.

Each cycle includes K data periods that are each associated with a period index k and are labeled DPₖ. In the example of FIG. 1C, each cycle includes two data periods (with k=1 and 2). In some instances, the frequency versus time pattern is the same for the data periods that correspond to each other in different cycles as is shown in FIG. 1C. Corresponding data periods are data periods with the same period index. As a result, each data period DP₁ can be considered corresponding data periods for that same channel index (i) and the associated frequency versus time patterns are the same in FIG. 1C. At the end of a cycle, the electronics return the frequency to the same frequency level at which it started the previous cycle.

During each data period, the frequency of the system output signal is varied at a constant rate. The rate can be zero but at least a portion of the data periods in each cycle have the system output signal varied at a non-zero rate. The direction and/or rate of the frequency change changes at the change of data periods from the same cycle. For instance, during the data period DP₁ and the data period DP₂, the electronics operate the light source such that the frequency of the system output signal changes at a linear rate. The direction of the frequency change during the data period DP₁ is the opposite of the direction of the frequency change during the data period DP₂.

The beat frequencies (f_{LDP}) from two or more different data periods in the same cycle can be combined to generate the LIDAR data. For instance, the beat frequency determined from DP₁ in FIG. 1C can be combined with the beat frequency determined from DP₂ in FIG. 1C to determine the LIDAR data for a sample region. As an example, the following equation applies during a data period where electronics increase the frequency of the outgoing LIDAR signal during the data period such as occurs in data period DP₁ of FIG. 1C: f_{ub}=−f_{d}+ατ where f_{ub} is the beat frequency determined from the output of the mathematical transformer 170, f_{d} represents the Doppler shift (f_{d}=2νf_{c}/c) where f_{c} represents the optical frequency (fₒ), c represents the speed of light, v is the radial velocity between the reflecting object and the LIDAR system where the direction from the reflecting object toward the LIDAR system is assumed to be the positive direction, and c is the speed of light. The following equation applies during a data period where electronics decrease the frequency of the outgoing LIDAR signal such as occurs in data period DP₂ of FIG. 1C: f_{db}=−f_{d}−α τ where f_{db} is the beat frequency determined from the output of the mathematical transformer 170. In these two equations, f_{d} and τ are unknowns. The electronics solve these two equations for the two unknowns. The radial velocity for the sample region then be determined from the Doppler shift (ν=c*f_{d}/(2f_{c})) and/or the separation distance for that sample region can be determined from c*f_{d}/2. Since the LIDAR data can be generated for each corresponding frequency pair output by the transform, separate LIDAR data can be generated for each of the objects in a sample region. Accordingly, the electronics can determine more than one radial velocity and/or more than one radial separation distance from a single sampling of a single sample region in the field of view.

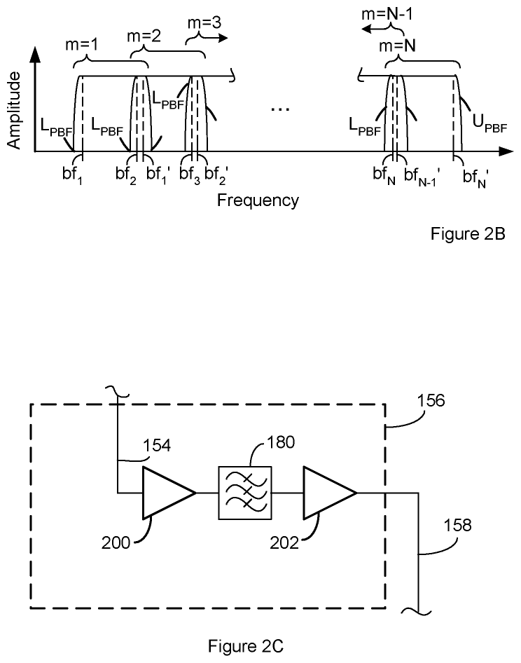

An example of a suitable bandpass filtration component 156 includes or consists of a current mirror that includes the bandpass filter and is configured to copy the electrical current through the data line 154 onto the associated filtered data line 158. Accordingly, the current through the data line 154 can serve as the reference current of the current mirror. Examples of suitable current mirrors include, but are not limited to, bandpass current mirrors. FIG. 2A illustrates an example of a bandpass current mirror suitable for serving as a bandpass filtration component 156. The illustrated current mirror includes a first transistor 174 and a second transistor 176. The first transistor 174 and the second transistor 176 illustrated in FIG. 2A are MOSFETs (metal-oxide-semiconductor field-effect transistor). The data line 154 is connected to the drain of the first transistor 174. The second sensor line 152 connects the sources of the first transistor 174 and the second transistor 176. In some instances, the second sensor line 152 is connected to a DC voltage source such that the sources of the first transistor 174 and the second transistor 176 are at the same DC voltage level. The filtered data line 158 is connected to the drain of the second transistor 176.

An electrical line 177 provides electrical communication between the gate of the first transistor 174 and the drain of the first transistor 174. A filter line 178 connects the gate of the transistor 174 to the gate of the transistor 174 through a band-pass filter 180 line 178 such that the channel signal output on the filtered data line 158 is filtered by the bandpass filter 180. As a result, the channel signal output on the filtered data line 158 is a representation of the preliminary channel signal filtered by the bandpass filter.

A bandpass current mirror can have constructions other than the construction shown in FIG. 2A. For instance, the MOSFETs illustrated in FIG. 2A can be replaced with other transistors and/or other switches. As one example, the illustrated MOSFETs can be replaced with BJTs having their bases connected by the filter line 178. Additionally, or alternately, the illustrated current mirror structure can get more sophisticated to improve its performance metrics such as the precision with which the current gets copied, nonlinearity of the copy mechanism or its noise. Techniques such as cascaded mirrors, gain-boosted mirrors and other known methods of improving current mirror performance in literature can all be applied to the current mirror.

Suitable bandpass filtration components 156 are not limited to bandpass current mirrors. For instance, rather than outputting a copy of the preliminary channel signal as occurs with a current mirror, the bandpass filtration components 156 can be configured such that the preliminary channel signal flows through the bandpass filtration component 156, is operated upon by the bandpass filtration component 156, and is then output by bandpass filtration component 156 as the channel signal. For instance, the bandpass filtration components 156 can be configured such that the preliminary channel signal flows through a transimpedance amplifier followed by bandpass filtration component 156 in voltage domain. However, additional signal processing may be required to add the outputs of the bandpass filters from different channels together. Alternately, each of the bandpass filters can serve as a different one of the filtration components 156. Accordingly, the representation of the preliminary channel signal output by the bandpass filtration component 156 can be the preliminary channel signal filtered by the bandpass filter in the bandpass filtration component 156.

FIG. 2C provides another example of a bandpass filtration component 156 that outputs the preliminary channel signal as the channel signal after the bandpass filtration component 156 operates on the preliminary channel signal. In FIG. 2C, a current to voltage converter 200, such as a transimpedance amplifier, receives the preliminary channel signal from the data line 154. The current to voltage converter 200 can amplify the current output of preliminary channel signal to a usable voltage that the current to voltage converter 200 outputs as a preliminary converted signal. The bandpass filter 180 receives the first converted signal and outputs a filtered signal. A voltage to current converter 202, such as a transconductance amplifier, receives the filtered signal from the bandpass filter 180. The voltage to current converter 202 converts the voltage of the filtered signal to a current that is output as the channel signal on the filtered data line 158. The bandpass filtration component 156 of FIG. 2C can exclude the voltage to current converter 202 and the adder can add the filtered signals. However, adding the voltages of the filtered signals would increase the complexity of the LIDAR system above the complexity if adding currents as would result from the configuration of FIG. 2C.

As noted above, the selection of the channel waveguides 30 that receive the LIDAR input signal can change in response to steering the system output signals to different sample regions within the field of view of the LIDAR system and/or in response to changes in the distance between the object and the LIDAR system. As a result, the LIDAR input signal has a different range of frequencies when the LIDAR input signal is received at different channel waveguides 30. Accordingly, the comparative signals carried by different channel waveguides 30 have different frequency ranges. Additionally, the channel signals output from different composite signal generators 130 are generated from LIDAR input signals received on different channel waveguides 30. Accordingly, the channel signals from different composite signal generators 130 each includes a contribution from comparative signals that carry different frequency ranges. As a result, channel signals generated by different composite signal generators 130 have different ranges of beat frequencies. The bandpass filters included in each of the composite signal generators 130 can be selected to pass the frequencies of the channel signals generated by the composite signal generator 130.

FIG. 2B illustrates the selection of bandpass filters for the bandpass filtration components 156 in different composite signal generators 130. FIG. 2B illustrates the passbands for the bandpass filters included in different composite signal generators 130. Each of the passbands includes a different range of frequencies that extends from a lower passband frequency (LPBF) to an upper passband frequency (UPBF). The range of frequencies in each of the passbands can include all or a portion of the range of beat frequencies received by the passband filter. For instance, the range of beat frequencies received by the passband filter associated with the channel index i can extend from the line labeled bfᵢ to the line labeled bfᵢ′ in FIG. 2B. In FIG. 2B, the range of frequencies in each of the passbands includes the full range of beat frequencies received by the passband filters. Further, the range of frequencies in the passband of all or a portion of the passband filters is larger than the range of beat frequencies received by the passband filter. In some instances, all or a portion of the bandpass filters are selected such that the range of beat frequencies received by the passband filter is more than 80%, or 100% and less than 120%, or 150% the range of frequencies in the passband.

As is evident from FIG. 2B, the range of beat frequencies for bandpass filters that receive signals from spatially adjacent channel waveguides 30 (i.e. composite signal generators 130 can be associated with channel index i=n and i=n+1) can overlap as a result of the Doppler frequency contribution to the beat frequencies of the channel signals because different objects at the same location in the field of view can generate different beat frequencies due to the contribution from the Doppler frequency to the beat frequency. As a result, FIG. 2B shows each of the passbands overlapping at least one other passbands. The overlap between adjacent passbands is a result of the presence of the Doppler frequency in the beat frequencies of the channel signals. In some instances, each of the passbands overlaps one or two other passbands. In some instances, each of the passbands overlaps one or two other passbands. In some instances, the passband for all a portion of the bandpass filters is overlapped by each of one or more other passbands by more than 5%, 10%, or 20% and less than 30%, 40%, or 50%. Additionally, or alternately, in some instances, the passband for all or a portion of bandpass filters is greater than 100 MHz, 200 MHz, or 500 MHz and less than 700 MHz, 800 MHZ, or 1 GHz. In some instances, the passbands are selected such that a beat frequency, a range of beat frequencies, or all of the beat frequencies received by the passband filters do not fall within the passbands of more than two of the passband filters. Suitable passband filters include, but are not limited to, switched-capacitor bandpass filters, active passband filters and inactive passband filters.

The bandpass filter can be made dynamic and/or programmable such that the electronics 56 can control one or more variables selected from the group consisting of the upper frequency of the passband, the lower frequency of the passband, and the range of the passband. For instance, the light source controller 63 can control the bandpass filters so as to shift the passband on the frequency spectrum. As an example, the light source controller 63 can control the bandpass filters so as to shift the passband toward lower frequencies, shift the passband toward higher frequencies, increase the frequency range and/or reduce the frequency range. As a result, the light source controller 63 can adjust the passband in response to the system output signals having different rates of change (a, different chirp rates) during different data periods. Changing the chirp rates changes the range of beat frequencies processed by each of the composite signal generators 130. As a result, the light source controller 63 can adjust the passbands to encompass the range of beat frequencies of each channel signal in response to changes in the chirp rate. Examples of dynamic and/or programmable include bandpass filters such as switched-capacitor filters.

The frequency range for the beat frequencies of the channel signals is low relative to the range of frequencies for the noise in the beat frequencies. As a result, the bandpass filters remove the noise from the channel signals before the noise is multiplied by adding multiple different channel signals. The use of the mirrors allows the current of the preliminary channel signal to be copied to the channel signal without permutation of the current of the preliminary channel signal. As a result, the channel signals can be filtered copies of the preliminary channel signals and the resulting data signal carried on the sensor output line 162 carries the added copies of the filtered preliminary channel signals.

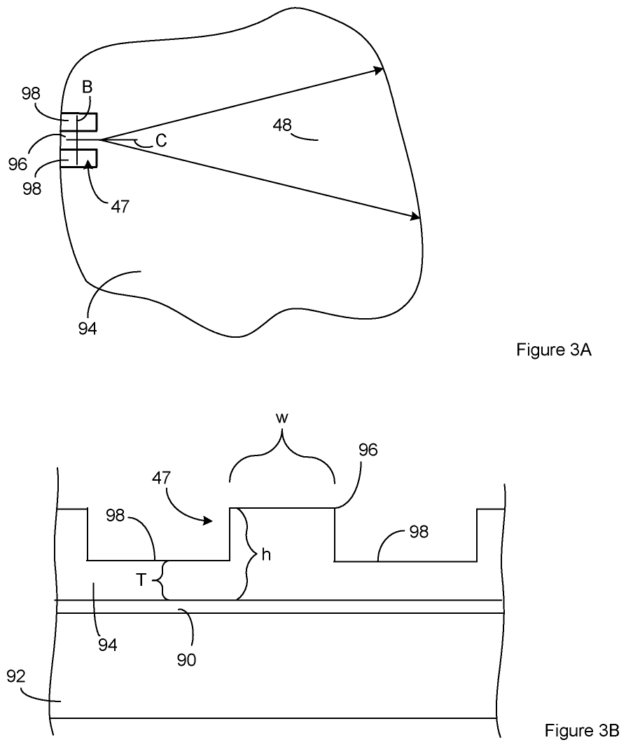

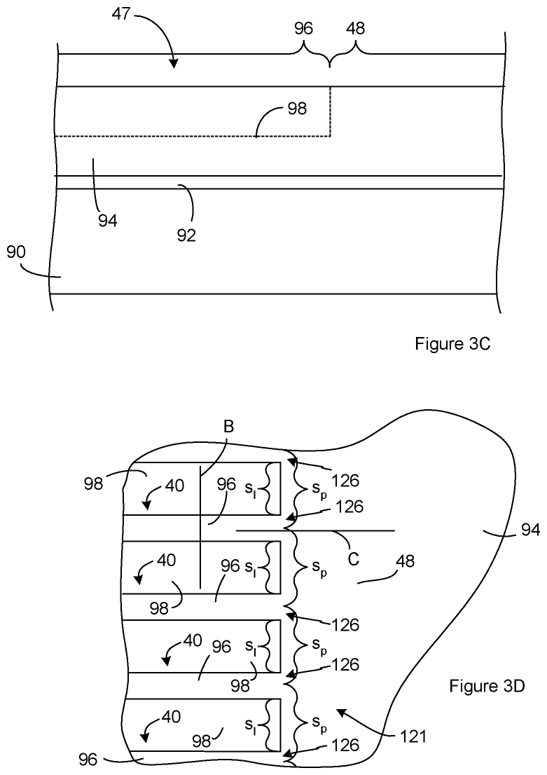

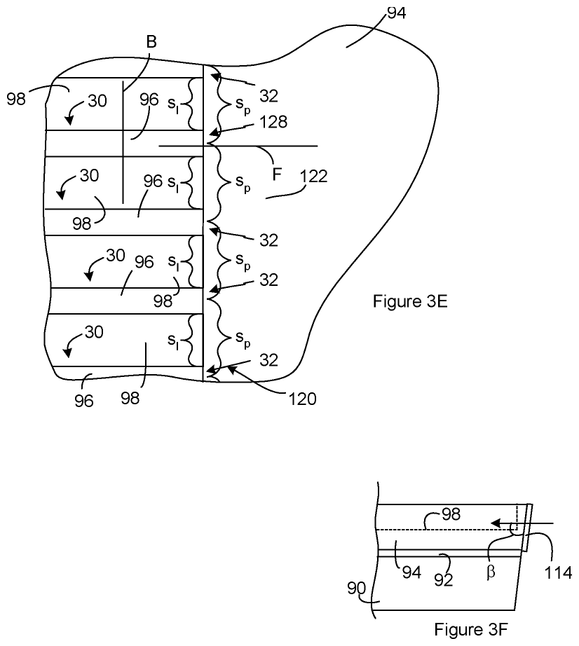

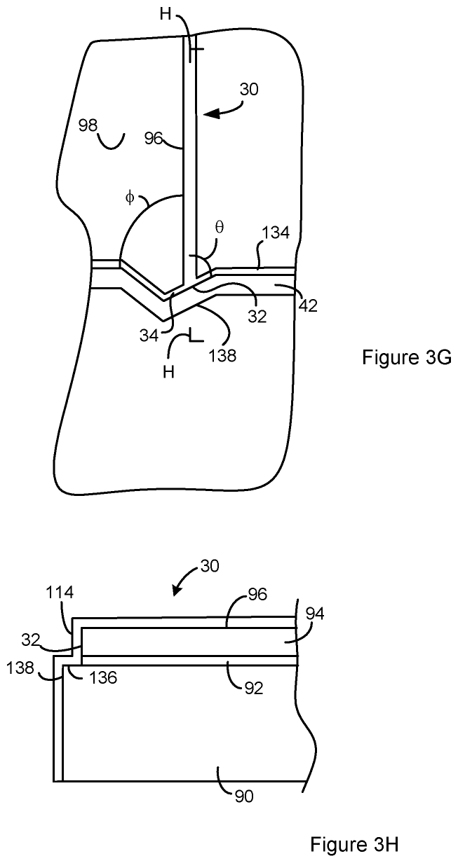

FIG. 3A through FIG. 3F illustrate an example of suitable constructions for free space regions and other components that are suitable for use with a LIDAR system constructed as shown in FIG. 1A. FIG. 3A is a topview of the interface between the free space region 48 and the reference waveguide 47. FIG. 3B is a cross section of the reference waveguide 47 taken along the line labeled B in FIG. 3A. FIG. 3C is a cross section of the interface between the reference waveguide 47 and the free space region 48 taken along the line labeled C in FIG. 3A.

Suitable platforms for the LIDAR chip include, but are not limited to, silica, indium phosphide, and silicon-on-insulator wafers. FIG. 3A through FIG. 3F illustrate different portions of the LIDAR chip constructed on a silicon-on-insulator platform. A silicon-on-insulator (SOI) wafer includes a buried layer 90 between a substrate 92 and a light-transmitting medium 94. In a silicon-on-insulator wafer, the buried layer 90 is silica while the substrate and the light-transmitting medium 94 are silicon. The substrate of an optical platform such as an SOI wafer can serve as the base for the LIDAR chip. For instance, the optical components shown in FIG. 1A and/or FIG. 1B can be positioned on or over the top and/or lateral sides of the same substrate.

The portion of the LIDAR chip illustrated in FIG. 3A through FIG. 3F uses a waveguide construction that is suitable for use with chips constructed from silicon-on-insulator wafers. A ridge 96 of the light-transmitting medium 94 extends away from slab regions 98 of the light-transmitting medium 94. In FIG. 3C, one of the slab regions 98 is illustrated by the dashed lines and is located behind the illustrated ridge 96. The light signals are constrained between the top of the ridge and the buried layer 90. As a result, the ridge 96 at least partially defines the waveguide.

The dimensions of the ridge waveguide are labeled in FIG. 3B. For instance, the ridge has a width labeled w and a height labeled h. The thickness of the slab regions is labeled T. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. Although the waveguide construction of FIG. 3B is disclosed in the context of the reference waveguide 47, the illustrated waveguide construction is suitable for any, all or a portion of the waveguides on a LIDAR chip constructed according to FIG. 1A.

The reference signal precursor and/or the reference signals travel through the free space region 48. The free space region 48 can be free space in the horizontal direction but guided in the vertical direction. As a result, the reference signal precursor and/or the reference signals can spread in the lateral directions and/or become more focused in the lateral directions. As a result, the free space region 48 can be a slab waveguide.

FIG. 3D is an example of a topview of an interface between an entry side of the second waveguide array 26 and the free space region 48. FIG. 3C can represent a cross section of the interface shown in FIG. 3D taken along the line labeled C in FIG. 3D. The second waveguide array 26 includes second array waveguides 40 that each terminates at port 126. FIG. 3B can represent a cross section of the second array waveguides 40 taken along the line labeled B in FIG. 3D. Light from the reference signal precursor can enter all or a portion of the second array waveguides 40 from the free space region 48. The light from the free space region 48 enters the second array waveguides 40 through the associated port 126.

The ports 126 in the second array waveguides 40 can be in a straight or curved arrangement. For instance, a curve fit to the centroids of all or a portion of the ports 126 can be a straight, arced, or curved line. In some instances, the ports 126 are arranged such that a curve fit to the centroids of all or a portion of the ports 126 is spherical, parabolic, or hyperbolic.

The distance between the centers of the entry ports 126 is labeled sₚ in FIG. 2H. The distance between the lateral sides of adjacent array waveguides 124 is labeled si in FIG. 2H. A suitable distance between the centers of the ports 126 (sₚ) includes distances greater than 2, 3, or 5 μm and/or less than 10, 30, or 50 μm. A suitable distance between the lateral sides of adjacent array waveguides (sₗ) includes distances greater than 0.2, 0.4, or 0.6 μm and/or less than 0.8, 1.0, or 1.2 μm.

FIG. 3E is a topview of a portion of the LIDAR chip where multiple channel waveguide(s) 30 terminate at a lateral side of the LIDAR chip. The facets 32 of adjacent channel waveguides 30 can be continuous as shown in FIG. 3E but can be spaced apart and/or non-continuous.

In FIG. 3E, the distance between the centers of the facets 32 is labeled sₚ. The distance between the lateral sides of adjacent channel waveguide(s) 30 at or near the facets 32 is labeled sₗ. The distances labeled sₚ and si can be selected such that movement of the LIDAR input signal across the facets of the channel waveguide(s) 30 does not result in substantial loss of the comparative signals. A suitable distance between the centers of the facets 32 (sₚ) includes distances greater than 2, 3, or 5 μm and/or less than 10, 30, or 50 μm. A suitable distance between the lateral sides of adjacent channel waveguide(s) 30 at or near the facets 32 includes distances greater than 0.2, 0.4, or 0.6 μm and/or less than 0.8, 1.0, or 1.2 μm.

The distance between the centers of the facets 32 (sₚ) need not be constant and can vary. For instance, the distance between the centers of the facets 32 may be lower for the facets 32 that receive the LIDAR input signals when the object is closer to the LIDAR system than the distance between the centers of the facets 32 that receive the LIDAR input signals when the object is further from the LIDAR system. Accordingly, the distance between the centers of the facets 32 (sₚ) can increase moving in one direction across the facets. For instance, the distance between the centers of the facets 32 (sₚ) can increase moving toward the facet 32 that is closest to the utility waveguide 12 or can decrease moving toward the facet 32 that is closest to the utility waveguide 12. In one example, the distance between the centers of each pair of adjacent facets 32 (sₚ) increases moving toward the facet 32 that is closest to the utility waveguide 12.

As shown in FIG. 1A, the array waveguides 124 can separate as they move away from the facets 32. For instance, the distance between the centers of the array waveguides and the distance between the lateral sides of adjacent array waveguides can increase as the array waveguides move away facets 32 and toward the composite signal generators 130. The increase in separation can be sufficient to allow the composite signal generator 130 to be positioned adjacent to one another and/or to be staggered as shown in FIG. 1A.

FIG. 3F can represent a cross section of the portion of the LIDAR chip shown in FIG. 3E taken along the line labeled F in FIG. 3E. For instance, FIG. 3F can be a cross section taken at through a facet 32 of a channel waveguide 30 and parallel to the direction of propagation of the LIDAR input signal in the channel waveguide 30 at the facet 32. The channel waveguide 30 terminates at the facet 32. The facet 32 can be at an angle β measured in a direction that is perpendicular to a plane of the LIDAR chip and relative to the direction of propagation of the LIDAR input signal. The plane of the LIDAR chip can be an upper surface of a substrate such as the substrate 92 of FIG. 3A through FIG. 3C. The angle β can be less than 90° in order to reduce the effects of back reflection on the LIDAR output signal(s). Suitable values for the angle β include angles less than or equal to 84°, 85° or 90° and/or greater than or equal to 78°, 80°, or 82°.

The facet 32 can optionally include an anti-reflective coating 114. Suitable anti-reflective coatings 114 include, but are not limited to, single layer dielectric coatings such as silicon nitride, multi-layer dielectric coatings including silica, hafnium oxide, and aluminum oxide. Although the facet construction of FIG. 3F is disclosed in the context of a facet 32 on the channel waveguide 30, the utility waveguide 12 can terminate at a facet constructed as disclosed in the context of FIG. 3F.

FIG. 3G and FIG. 3H illustrate another possible configuration for the termination of the channel waveguide(s) 30 at a lateral side of the LIDAR chip. FIG. 3G is a topview of the device. FIG. 3H is a cross section of the device taken along the line labeled H in FIG. 3G.

A flange ridge 134 is defined in the light-transmitting medium 94 and extends outwards from the ridge 96 at the facet 32. The flange ridge 134 can be an artifact of the fabrication process and, in some instances, is not present in the optical device. When a flange ridge is present on the optical device, the facet 32 corresponds to the portion of the flange region 134 through which the light signals are transmitted into the channel waveguide 30. As a result, the facet 32 can be the portion of the flange region 134 that is optically aligned with the waveguide. Suitable light-transmitting media include, but are not limited to, silicon, polymers, silica, SiN, GaAs, InP and LiNbO₃.

The facet 32 extends upwards from a facet shelf 136. The facet shelf 136 extends outward from the facet 32 toward the lateral side 138 of the chip and is on an opposite side of the facet 32 from the channel waveguide 30. In some instances, the facet shelf 136 is parallel or substantially parallel to the top of the substrate 90.

In some instances, the facet 32 is vertical or substantially vertical relative to the top of the substrate 90. The facet 32 can also be positioned at an angle that is non-perpendicular relative to the direction of propagation of light signals through the channel waveguide 30 at the facet 32. In some instances, the facet 32 is substantially perpendicular relative to the top of the substrate 90 while being non-perpendicular relative to the direction of propagation. Suitable angles (labeled θ in FIG. 3G) for the facet 32 relative to the direction of propagation include but are not limited to, angles between 80° and 89°, and angles between 80° and 85°. An angle (labeled ϕ in FIG. 32) between the direction of propagation of light signals through the channel waveguide 30 at the facet 32 and the plane of the lateral side 138 can be less than or equal to 90°. For instance, the angle ϕ can be greater than 60° or 80° and/or less than 80° or 90°. The angle ϕ and the angle θ can be selected such that the LIDAR input signal enter the channel waveguide at an angle within a desired angular range. For instance, the angle ϕ and the angle θ can be selected such that light the LIDAR input signal entering the channel waveguide travels through the channel waveguide in a direction that is parallel or substantially parallel to the direction of propagation of light signals through the channel waveguide 30 at the facet 32.

Although not shown in FIG. 3A through FIG. 3G, a cladding can optionally be positioned on the device. The cladding can be arranged so it is located on the channel waveguides 30 without being located over the facets 32. For instance, the cladding can be in direct physical contact with the ridge 96 of the light-transmitting medium and the slab regions without being in direct physical contact with the facets 32. Suitable claddings include, but are not limited to, silica and silicon nitride.

The above LIDAR chip construction is suitable for use with various signal shapers and beam steerers. Examples of suitable beam steerers include, but are not limited to, actuated optical gratings, mirrors such as mechanically driven mirrors and Micro Electromechanical System (MEMS) mirrors, voice coil mirrors, piezoelectrically driven mirrors, and optical phased arrays. Examples of suitable signal shapers include, but are not limited to, collimating devices, lenses, and mirrors.

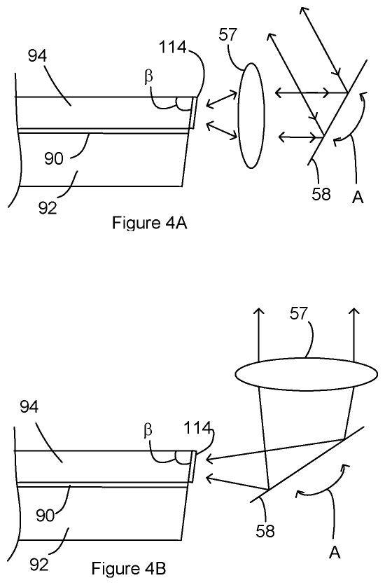

FIG. 4A is a cross section of a portion of a LIDAR system showing an example of an interface between a channel waveguide 30 constructed on a silicon-on-insulator platform, a beam steerer 58 and a first signal shaper 57. A lens serves as the first signal shaper 57 and can provide collimate or focus the shaped output signal output from the first signal shaper 57. A mirror serves as a beam steerer 58 that receives the shaped output signal and outputs the system output signal in the desired direction. As is illustrated by the arrow labeled A, the steering controller 15 in the electronics can control movement of the mirror so as to steer the collimated or focused system output signal(s) and/or scan the collimated or focused system output signal(s). The movement of the mirror can be in two dimensions or three dimensions. Suitable mirrors include, but are not limited to, mechanically driven mirrors and Micro Electromechanical System (MEMS) mirrors.

Although FIG. 4A illustrates one or more signal shapers between the LIDAR chip and one or more beam steerers, the LIDAR system can include one or more beam steerers between the LIDAR chip and one or more signal shapers. For instance, FIG. 4B illustrates the beam steerer 58 between the LIDAR chip and the first signal shaper 57.

The light sensors are illustrated as photodiodes in FIG. 1C, other light sensors are suitable. Suitable light sensors include photodiodes and other types of light sensors that can be bonded to the LIDAR chip rather than integrated with the LIDAR chip. In some instances, all or a portion of the light sensors are integrated with the LIDAR chip. For instance, the light sensors can be in-line light sensors that are each integrated with one of the array waveguides.

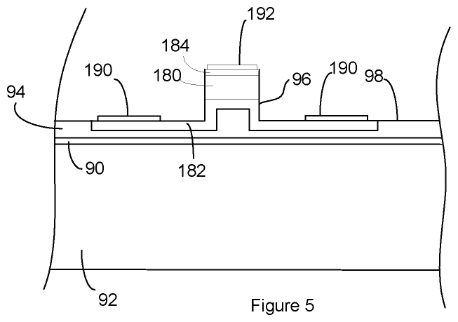

FIG. 5 provides a cross section of an in-line light sensor that is suitable for use in the above LIDAR chips. The light sensor is illustrated on a silicon-on-insulator (SOI) platform although the light sensor can be constructed on other platforms. The light sensor is integrated with a waveguide having a structure as disclosed in FIG. 3B.

The light sensor includes a light-absorbing medium 180 positioned to receive light from the waveguide. For instance, a light-absorbing medium 180 can be located on top of the ridge 96 of the light-transmitting medium 94. As a result, a portion of the light signal traveling through the waveguide enters the light-absorbing medium 180. For instance, the light-absorbing medium 180 can be configured such that the fundamental mode is coupled upward into the light-absorbing medium 180 from the light-transmitting medium 94. For instance, the index of refraction of the light-absorbing medium 180 can be higher than the index of refraction of the light-transmitting medium 94.

The light-transmitting medium 94 includes a first doped region 182 positioned in a portion of the light-transmitting medium 94 located between the light-absorbing medium 180 and the substrate 92. In some instances, the first doped region 182 contacts the light-absorbing medium 180. The light-absorbing medium 180 includes a second doped region 184. A portion of the light-absorbing medium 180 is located between the second doped 34 region and the first doped region 182.

When the first doped region 182 includes an n-type dopant, the second doped region 184 includes a p-type dopant and when the first doped region 182 includes a p-type dopant, the second doped region 184 includes an n-type dopant. Suitable dopants for N-type regions include, but are not limited to, phosphorus and/or arsenic. Suitable dopants for P-type regions include, but are not limited to, boron. A suitable concentration of carriers in the p-type region includes values greater than 1×10¹⁴/cm³, 1×10¹⁶/cm³, 1×10¹⁷/cm³, and/or less than 1×10¹⁸/cm³, 1×10¹⁹/cm³, 1×10²¹/cm³. A suitable value for the concentration of carriers in the n-type region includes values greater than 1×10¹⁴/cm³, 1×10¹⁶/cm³, 1×10¹⁷/cm³, and/or less than 1×10¹⁸/cm³, 1×10¹⁹/cm³, 1×10²¹/cm³.

The first doped region 182 is in contact with one or more first electrical conductors 190 such as a metal. The second doped region is in contact with one or more second electrical conductors 192 such as a metal. Electrical energy can be applied to the one or more first electrical conductor 190 and the one or more second electrical conductors 192 in a reverse bias so as to form an electrical field in the light-absorbing medium 180. When the electrical field is formed and the light-absorbing material absorbs a light signal, an electrical current flows through the light-absorbing material. As a result, the level of electrical current through the light-absorbing material indicates the intensity of light signals being received by the light-absorbing material.

A light-absorbing medium 180 that is suitable for detection of light signals used in LIDAR applications includes, but is not limited to, Ge.

One or more components selected from the group consisting of the mathematical transformer 170, steering controller 15, light source controller 63, data processor 155, LIDAR data generator 172, can execute the attributed functions using firmware, hardware or software or a combination thereof. In addition, or in conjunction, with the electronics 56 disclosed above, the electronics 56 can include, but are not limited to, an electronic controller that includes or consists of analog electrical circuits, digital electrical circuits, processors, microprocessors, digital signal processors (DSPs), Application Specific Integrated Circuits (ASICs), Field Programmable Gate Arrays (FPGAs), computers, microcomputers, or combinations suitable for performing the operation, monitoring and control functions described above. In some instances, the electronic controller has access to a memory that includes instructions to be executed by the electronic controller during performance of the operation, control and monitoring functions. Although the electronics are illustrated as a single component in a single location, the electronics can include multiple different components that are independent of one another and/or placed in different locations. Additionally, all or a portion of the disclosed electronics can be included on the chip including electronics that are integrated with the chip.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to output a system output signal and to receive a system return signal that includes light from the system output signal that was reflected by an object located outside of the LIDAR system;
the LIDAR system including data lines that each carries a different preliminary channel signal,
a portion of the preliminary channel signals beating at a beat frequency,
each of the preliminary channel signals in the portion of the preliminary channel signals being generated from the system return signal;
the LIDAR system including bandpass filter components that each receive a different one of the preliminary channel signals and outputs a channel signal on a different filtered data line,
the channel signal output by each of the bandpass filter components being a representation of the preliminary channel signal received by the bandpass filter component filtered by one or more bandpass filters included in the bandpass filter component.

2. The system of claim 1, wherein each of the bandpass filters has a passband with a different range of frequencies.

3. The system of claim 2, wherein the frequency ranges of the passbands from different bandpass filters overlap.

4. The system of claim 1, wherein the LIDAR system includes multiple channel waveguides and a selection of the channel waveguides receives the LIDAR input signal,
the LIDAR input signal includes light from the system return signal, and
the selection of the channel waveguides that receives the LIDAR input signal changes in response to changes in the location of the object relative to the LIDAR system.

5. The system of claim 4, wherein the portion of the preliminary channel signals beating at the beat frequency changes in response to changes in the selection of the channel waveguides that receives the LIDAR input signal.

6. The system of claim 4, wherein the portion of the LIDAR input signal received by one of the channel waveguides serves as a comparative signal,
each of the channel waveguides can be associated with a channel index with a value from m=1 to M and each of the data lines can also be associated with one of the channel indices,
each of the preliminary data signals being generated from a different one of the comparative signals,
the preliminary data signal carried by each of the data lines being generated from the comparative signal that is guided by the channel waveguide associated with the same channel index as the data line carrying the preliminary data signal, and
the channel indices for the data lines that carry the portion of the preliminary channel signals beating at the beat frequency matching the channel indices for the portion of the channel waveguides that receives the LIDAR input signal.

7. The system of claim 1, wherein the LIDAR system includes a signal adder configured to add the channel signal together.

8. The system of claim 1, wherein the LIDAR system includes electronics that include a beat frequency identifier configured to calculate the beat frequency.

9. The system of claim 1, wherein each of the bandpass filter components includes a current mirror and each of the current mirrors includes the one or more bandpass filters included in the bandpass filter component,
each current mirror configured such that the channel signal output by each bandpass filter component is a copy of the preliminary channel signal received by the bandpass filter component.

10. The system of claim 1, wherein the current mirrors each include a filter line connecting the gates of different transistors or connecting the bases of different transistors.

11. The system of claim 10, wherein one of the bandpass filters is positioned along each of filter lines.

12. The system of claim 1, wherein the channel waveguides are configured such that a range of the beat frequencies carried by each of the preliminary data signals is different.

13. The system of claim 12, wherein each of the bandpass filters has a passband that encompasses the range of beat frequencies for the preliminary data signal received by the bandpass filter component that includes the bandpass filter.

14. The system of claim 1, wherein a portion of the preliminary channel signals is not beating at the beat frequency.

15. The system of claim 14, wherein the portion of the preliminary channel signals beating at the beat frequency changes in response to changes in a location of the object relative to the LIDAR system.
